(19) United States
(12) Patent Application Publication
(10) Pub. No.: US 2010/0244505 A1
(43) Pub. Date: Sep. 30, 2010

(54) Video Screen Assembly For Vehicle

(75) Inventors: Robert L. Demick, Macomb Township, MI (US); Daniel W. Booth, Warren, MI (US); John M. Coleman, Davisburg, MI (US); Ralph C. Dewitt, Shelby Township, MI (US); Jonathan E. Kring, Clinton Township, MI (US); Paul J. Dulman, III, Clinton Township, MI (US); Jesse J. Brinster, Redford, MI (US); Patrick B. Usoro, Troy, MI (US); Xiujie Gao, Troy, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/414,750

(22) Filed: Mar. 31, 2009

(51) Int. Cl. B60N 3/00; A47C 7/62; B60R 7/04; B60N 2/64; B60N 2/44; H04N 5/64

(52) U.S. Cl. 297/188.04; 296/37.8; 296/37.16; 348/837; 348/E05.128

(57) ABSTRACT

A screen apparatus includes a screen assembly and structure. The structure defines a cavity having an opening to a vehicle passenger compartment. The screen assembly includes a frame and a video screen mounted with respect to the frame. The screen assembly is selectively movable between a retracted position in which the screen is inside the cavity and concealed from view, and a deployed position in which the screen is outside the cavity and visible from the passenger compartment. The screen apparatus is configured such that the movement of the screen assembly between the retracted and deployed positions is restricted to substantially linear translation.

### TECHNICAL FIELD

This invention relates to video screens for use in automotive interiors.

### BACKGROUND OF THE INVENTION

A typical automotive vehicle includes a body defining a passenger compartment containing passenger seats for supporting vehicle passengers. Some vehicles include display screens for displaying vehicle information, such as outside temperature, directional information, tire pressure, or any other data stored within a vehicle controller. Additionally, the screens may be connected to other devices such as digital video disc (DVD) units or video gaming units, thereby allowing vehicle occupants a number of entertainment options. Furthermore, the screens may be configured to display intricate navigational information, such as maps or printed directions, thereby allowing a driver to access information within the passenger compartment.

### SUMMARY OF THE INVENTION

A vehicle includes a vehicle body defining a passenger compartment, and a screen apparatus including a screen assembly and structure. The structure defines a cavity having an opening to the passenger compartment. The screen assembly includes a frame and a video screen mounted with respect to the frame. The screen assembly is selectively movable through the opening between a retracted position in which the screen is inside the cavity and concealed from view, and a deployed position in which the screen is outside the cavity and visible from the passenger compartment. The screen apparatus is configured such that the movement of the screen assembly between the retracted and deployed positions is restricted to substantially linear translation.

The screen apparatus provides improved video screen packaging efficiency compared to the prior art, and thereby improves the perceived spaciousness of a vehicle interior. The screen apparatus also provides improved protection of the screen when not in use because the screen is protected by the panel in its retracted position.

A vehicle seat assembly is also provided. The vehicle seat assembly includes a seat having a lower seat portion and a seatback portion mounted with respect to the lower seat portion. A panel is mounted with respect to the seatback portion. A screen assembly includes a frame and a video screen mounted with respect to the frame. The screen assembly is selectively movable between a retracted position in which the screen is obstructed by the panel and a deployed position in which the screen is not obstructed by the panel. Movement of the screen assembly between the retracted and deployed positions is restricted to substantially linear translation.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, perspective, rear view of a vehicle seat having first and second interfaces for receiving modules;

FIG. 2 is a schematic, perspective, rear view of a first module that includes storage doors and that is matable with the first interface;

FIG. 3 is a schematic, perspective, rear view of a second module that includes a video screen and that is matable with the second interface;

FIG. 4 is a schematic, perspective, rear view of the seat of FIG. 1 with the module of FIG. 2 engaged with the first interface and a third module engaged with the second interface;

FIG. 5 is a schematic, perspective, rear view of the seat of FIG. 1 with the module of FIG. 2 engaged with the first interface and a fourth module engaged with the second interface;

FIG. 6 is a schematic, perspective, rear view of the seat of FIG. 1 with the module of FIG. 3 engaged with the first interface and with the screen in a retracted position;

FIG. 7 is a schematic, perspective, rear view of the seat of FIG. 1 with the module of FIG. 3 engaged with the first interface and with the screen in a deployed position;

FIG. 8 is a schematic, perspective view of a portion of screen apparatus;

FIG. 9 is a schematic, front view of the screen apparatus of FIG. 8;

FIG. 10 is a schematic, rear view of the screen apparatus of FIG. 8;

FIG. 11 is a schematic, sectional view of the screen apparatus of FIG. 8;

FIG. 12 is a schematic, rear view of another screen apparatus including a video screen with the screen in a deployed position;

FIG. 13 is a schematic, rear view of the screen apparatus of FIG. 12 with the screen in a retracted position; and

FIG. 14 is a schematic, sectional, side view of a vehicle.

### DESCRIPTION OF THE PREFERRED EMBODIMENTS

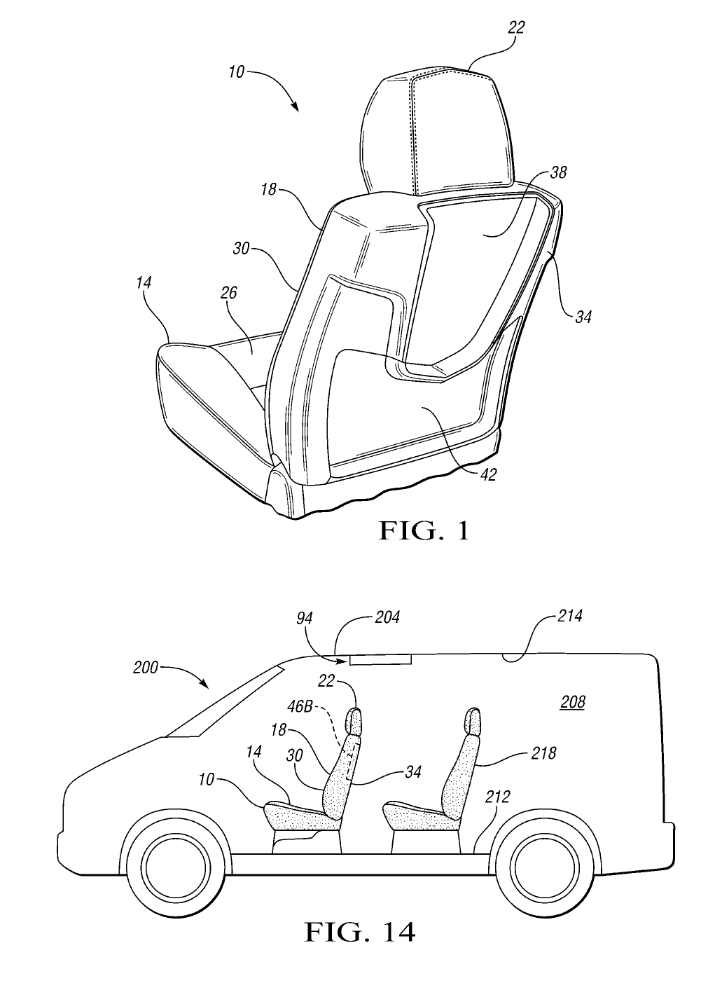

Referring to FIG. 1, a vehicle seat 10 is schematically depicted. The vehicle seat 10 includes a lower seat portion 14, a seatback portion 18, and a head restraint 22. The lower seat portion 14 defines a surface 26 that is generally horizontal and that faces generally upward for supporting an occupant (not shown). The seatback portion 18 is mounted with respect to the lower seat portion 14 and defines a generally vertical surface 30 for supporting the back of the occupant. In the embodiment depicted, the seatback portion 18 is selectively rotatable with respect to the lower seat portion 14 so that the reclination angle of the occupant is selectively variable, as understood by those skilled in the art. The headrest 22 is mounted with respect to the seatback portion 18 adjacent the upper edge of the seatback portion 18. The vehicle seat 10 may, for example, be installed or configured for use in an automotive vehicle, aircraft, a passenger train, etc.

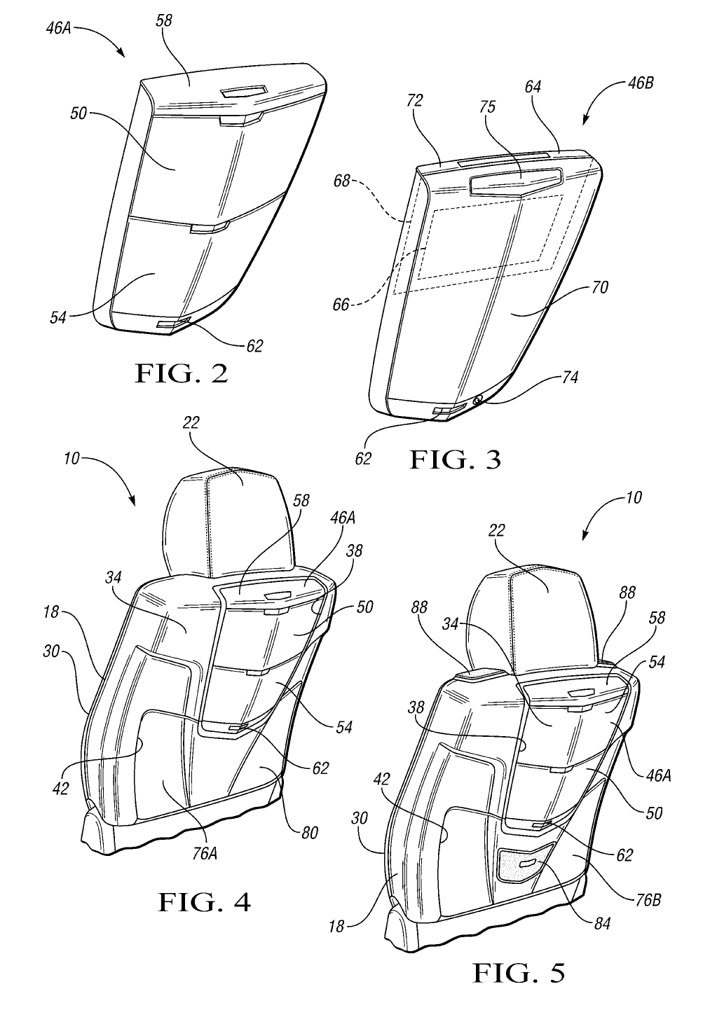

The rearward surface 34 of the seatback portion 18, which is opposite the occupiable surface 30 of the seatback portion 18, defines two cavities 38, 42. Referring to FIG. 2, a module 46A is schematically depicted. Module 46A is fittable within the concavity shown at 38 in FIG. 1, and defines three doors 50, 54, 58 that are selectively rotatable between respective open and closed positions to selectively provide access to storage compartments, as understood by those skilled in the art. The doors 50, 54, 58 are depicted in their respective closed positions in FIG. 2. Module 46A also includes a light source 62, which, in the embodiment depicted, is a light emitting diode. The module 46A is mountable to the seatback portion, shown at 18 in FIG. 1, by a snap-fit engagement with the surfaces defining the concavity 38. Those skilled in the art will recognize other mounting techniques and apparatuses for connecting the module 46A to the seatback portion 18 that may be employed within the scope of the claimed invention, such as threaded fasteners, latches, etc.

Referring to FIG. 3, module 46B is fittable within the concavity shown at 38 in FIG. 1. The module 46B is mountable to the seatback portion, shown at 18 in FIG. 1, by a snap-fit engagement with the surfaces defining the concavity 38. Those skilled in the art will recognize other mounting techniques and apparatuses for connecting the module 46B to the seatback portion 18 inside the concavity 38 that may be employed within the scope of the claimed invention, such as threaded fasteners, latches, etc.

Module 46B is differently configured than module 46A. More specifically, module 46B includes a video screen apparatus having a video screen assembly 64. The video screen assembly includes a video screen 66. In an exemplary embodiment, the video screen 66 is a liquid crystal display (LCD) screen. The video screen assembly 64 also includes a frame 68 to which the screen 66 is mounted for movement therewith. The frame 68 provides structural support to the screen 66, and may have any configuration within the scope of the claimed invention. The module 46B also includes a panel 70. The video screen assembly 64 is shown in a retracted position in FIG. 3. When the screen assembly 64 is in its retracted position, the screen 66 is behind, and obstructed by, the panel 70, and the upper surface 72 of the frame 68 is exposed and defines part of the upper surface of the module 46B. The module 46B also includes a video jack 74 and an infrared (IR) lens 75. In the embodiment depicted, the lens 75 is mounted with respect to the panel 70. In an alternative embodiment (not shown) the lens 75 is mounted with respect to the frame 68.

Referring to FIGS. 1-3, modules 46A and 46B have substantially the same size and shape as the concavity (shown at 38 in FIG. 1) formed in the rearward surface 34 of the seatback portion 18, and are thus interchangeably mountable thereto. Referring to FIG. 4, wherein like reference numbers refer to like components from FIGS. 1-3, module 46A is mounted to the seatback portion 18 of vehicle seat 10 such that the module 46A is within concavity 38. Storage doors 50, 54, 58 are accessible to a rear seat passenger sitting behind vehicle seat 10.

Module 76A is substantially the same size and shape as concavity 42. Module 76A is mounted to the seatback portion 18 such that the module 76A is within the concavity 42. Module 76A includes a storage door 80 that is shown in a closed position. The door 80 is selectively rotatable to an open position to expose a map pocket. The light source 62 of module 46A is positioned to selectively illuminate the map pocket of module 76A when the door 80 is open, or to illuminate the floor of the vehicle behind seat 10.

Referring to FIG. 5, wherein like reference numbers refer to like components from FIGS. 1-4, module 76B is substantially the same size and shape as concavity 42. Module 76B is mounted to the seatback portion 18 such that the module 76B is within the concavity 42. Thus, modules 76A and 76B are selectively interchangeable, which provides flexibility in configuring the vehicle seat 10.

Module 76B has a configuration that is different than the configuration of module 76A. More specifically, module 76B includes a speaker 84, which, in the embodiment depicted, is a sub-woofer. Accordingly, module 76B may, for example, be used as part of a sound system upgrade package that includes the addition of speakers 88. Speakers 88 are mounted to the top of the seatback portion 18 on opposite sides of the head restraint 22.

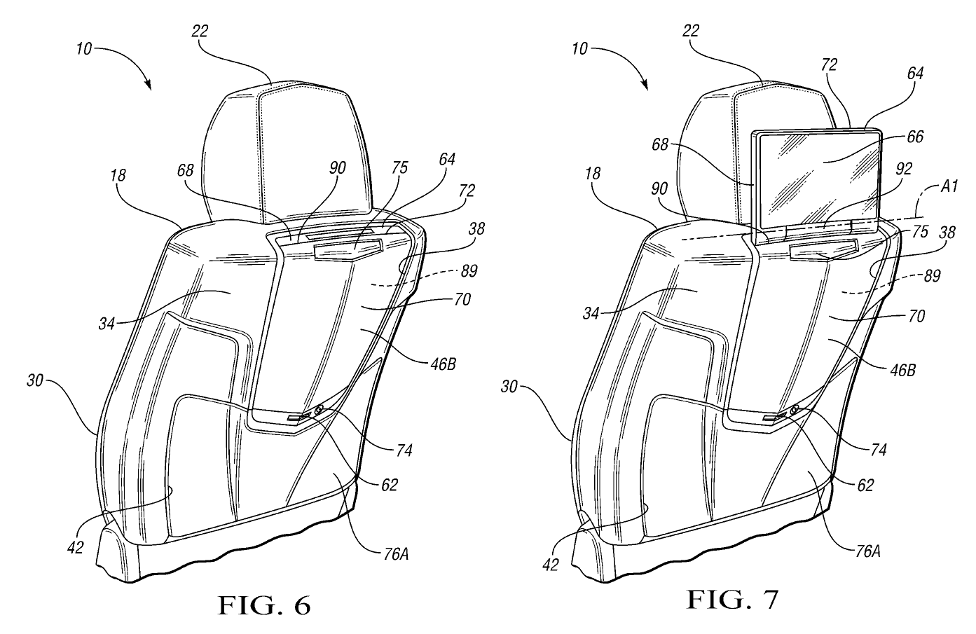

Referring to FIG. 6, wherein like reference numbers refer to like components from FIGS. 1-5, module 46B is mounted to the seatback portion 18 of vehicle seat 10 such that the module 46B is within concavity 38. Panel 70 and the seatback portion 18 cooperate to define a cavity 89 therebetween. The cavity 89 includes an opening, namely slot 90. When the seat 10 is installed in a vehicle, the cavity 89 is open to the passenger compartment (shown at 208 in FIG. 14) via the slot 90. The screen assembly 64 is shown in its retracted position in FIG. 6. When the screen assembly 64 is in its retracted position, the screen (shown at 66 in FIGS. 3 and 7) is entirely between the panel 70 and the seatback portion 18 of the vehicle seat 10, and is therefore concealed and protected.

The module 46B is configured such that the screen assembly 64 is selectively translatable from its retracted position, as shown in FIG. 6, to a deployed position, as shown in FIG. 7. Referring to FIG. 7, when the screen assembly 64 is in its deployed position, the screen 66 is above, and therefore not obstructed by, the panel 70. More specifically, the screen 66 is unobstructed and facing rearward such that the screen 66 is viewable by a rear seat passenger sitting behind the vehicle seat 10 in the passenger compartment. The screen assembly 64 includes a carriage member 92 that is operatively connected to the screen frame 68 such that the carriage member 92 and the screen frame 68 are translatable together as the screen assembly 64 translates between its retracted and deployed positions.

The frame 68 is rotatably mounted to the carriage member 92 (such as via a hinge) such that the frame 68 and the screen 66 are selectively rotatable about a horizontal, transverse axis A1 to adjust the screen's viewing angle. The panel 70 and the seatback portion 18 restrict movement of the screen frame 68 to linear translation until the screen assembly 64 is in the deployed position and the pivot axis A1 is outside the cavity defined by the panel 70 and the seatback portion 18. The rotation of the screen assembly about the transverse axis A1 may be realized by manual operation or by the use of an actuator (not shown). Electrical connectors (not shown) are provided to establish electrical communications between the screen 66 and a power source (not shown) to power the screen, and a signal source (not shown) such as a DVD player, navigation system, etc. The lens 75 may be used to transmit signals to headphones (not shown).

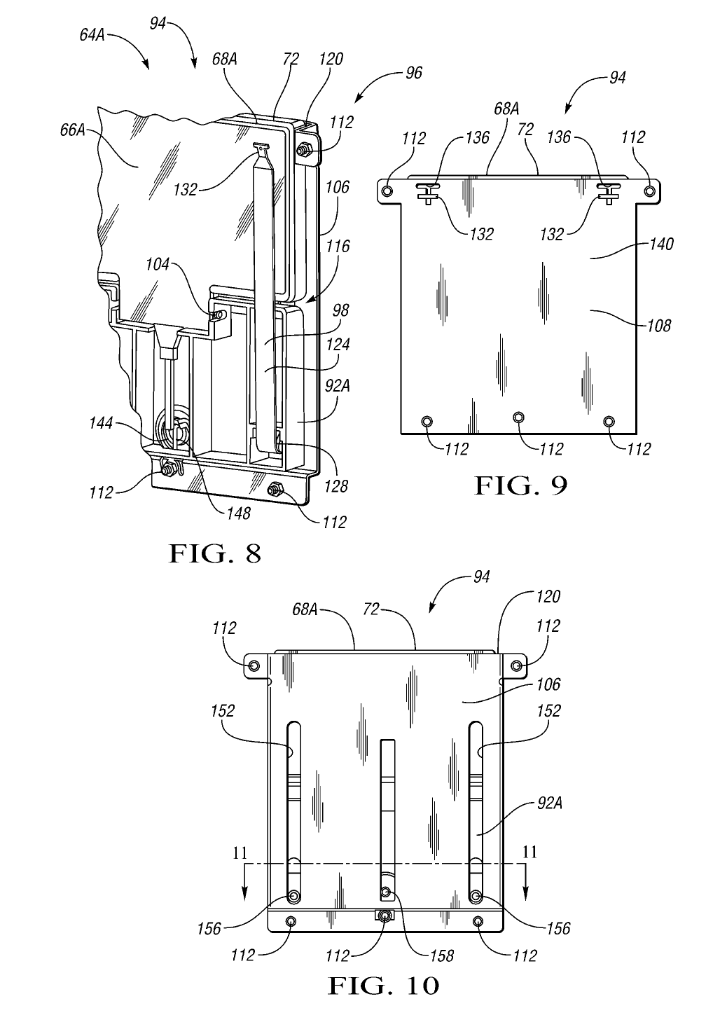

FIG. 8 is a schematic depiction of an alternative screen apparatus 94, which is mountable to the rear surface 34 of the seatback portion 18. Referring to FIG. 8, wherein like reference numbers refer to like components from FIGS. 1-7, the apparatus 94 includes a screen assembly 64A, a screen guide assembly 96, and at least one actuator 98. In the embodiment depicted, the apparatus 94 includes two actuators 98 (only one of which is shown in FIG. 8). The screen assembly 64A includes screen frame 68A, carriage member 92A, and screen 66A. Screen frame 68A is characterized by an upper surface 72. The screen frame 68A is rotatably mounted with respect to carriage member 92A via a pin 104. Screen 66A (the rear of which is seen in FIG. 8) is mounted to the screen frame 68A for movement therewith.

Referring to FIGS. 8-10, the guide assembly 96 includes a first panel 106 and a second panel 108. The second panel 108 is mounted to the first panel 106 via threaded fasteners 112 such that the second panel 108 and the first panel 106 cooperate to define a cavity 116 therebetween. The first and second panels 106, 108 also define a slot 120 at the upper end of the cavity 116. When the screen apparatus 94 is installed in a vehicle, the cavity 116 is open to the passenger compartment via slot 120.

The screen assembly 64A is selectively translatable with respect to the guide assembly 96 between a retracted, lowered position, as shown in FIGS. 8-10, and a deployed, elevated position substantially similar to the deployed position of the screen assembly shown at 64 in FIG. 7. When the screen assembly 64A is in the retracted position, the screen 66A and frame 68A are at least partially contained within the cavity 116 between the first and second panels 106, 108. More particularly, when the screen assembly 64A is in its retracted position, most or all of the screen frame 68A is below the slot 120 so that the screen 66A is obstructed and protected by the first panel 106. In the embodiment depicted, the upper surface 72 of the screen frame 68A protrudes above the slot 120 when the screen assembly 64A is in its retracted position.

The actuators 98 are configured to selectively raise the screen assembly 64A from its retracted position to its deployed position. In the embodiment depicted, the actuators 98 are springs 124. One end of each spring 124 is mounted to the carriage member 92A at a respective spring roller 128. Each spring 124 includes a respective end 132 opposite the spring roller 128. Ends 132 are T-shaped. The ends 132 of the springs 124 are operatively connected to the second panel 108. More specifically, and with reference to FIG. 9, the second panel 108 defines two T-shaped apertures 136. The ends 132 are mounted to the second panel 108 by positioning the ends 132 through the apertures 136 such that the ends 132 are outside the cavity 116 and restrained by the surface 140 of the second panel 108, as shown in FIG. 9.

The springs 124 and apertures 136 are positioned and configured such that movement of the screen assembly 64A relative to the second panel 108 from its deployed, elevated position to its retracted, lowered position elastically strains the springs 124. Accordingly, when the screen assembly 64A is in its retracted, lowered position, the springs 124 exert an upward force on the screen assembly 64A at the carriage member 92A, which urges the screen assembly upward and toward the deployed position.

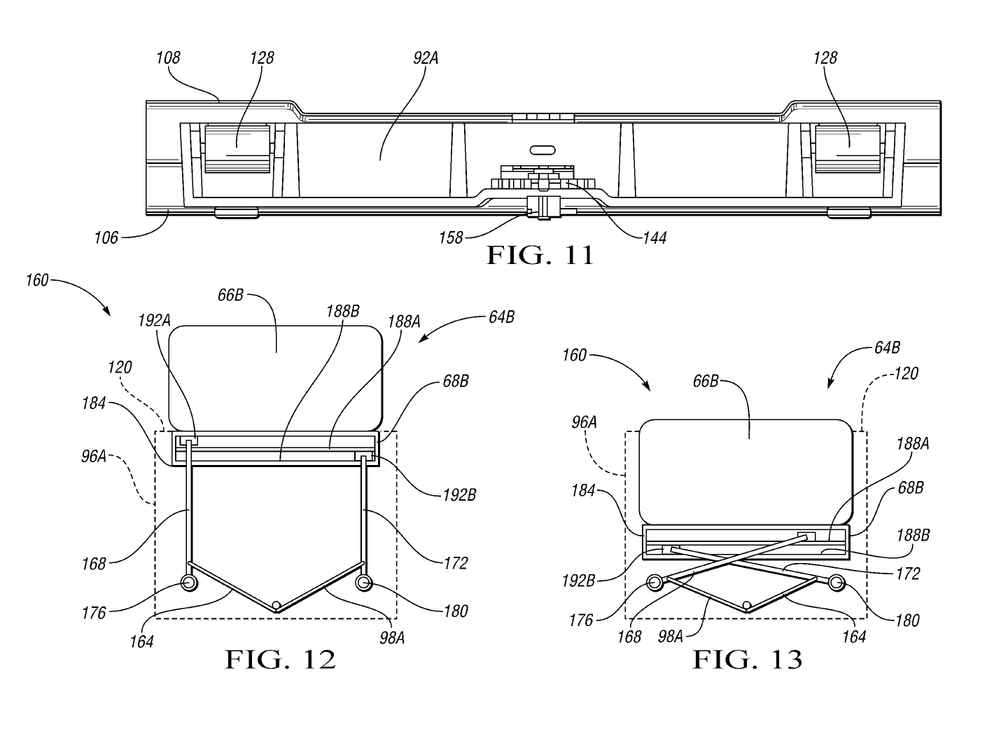

Referring again to FIGS. 8-11, the apparatus 94 includes a latch 144 and a striker 148. In the embodiment depicted, the latch 144 is mounted with respect to the carriage member 92A and the striker 148 is mounted with respect to the guide assembly 96. However, and within the scope of the claimed invention, the latch 144 may be mounted with respect to the guide assembly 96 and the striker 148 may be mounted with respect to the carriage member 92A. The striker 148 and the latch 144 are positioned such that the striker 148 engages the latch 144 when the screen assembly 64A is moved to its retracted position. Accordingly, the latch 144 releasably maintains the screen assembly 64A in its retracted position.

As understood by those skilled in the art, the latch 144 is configured to selectively disengage the striker 148. When the latch 144 disengages the striker 148, the upward force exerted by the springs 124 on the carriage member 92A causes the screen assembly 64A to move upward to its deployed position. The width of the cavity 116, i.e., the distance between the first and second panels 106, 108, is such that the movement of the screen assembly 64A between the deployed and retracted positions is substantially limited to linear translation.

When the screen assembly 64A is in its deployed position, the screen 66 and the pin 104 are above the slot 120 so that the screen 66A is unobstructed and viewable by rear seat passenger, and the frame 68A is rotatable about the pin 104 to adjust the viewing angle of the screen 66A, similar to the screen frame and screen shown at 68 and 66, respectively, in FIG. 7.

In the embodiment depicted, the latch 144 is a toggle latch. Accordingly, when the screen assembly 64A is in its retracted position, the latch 144 is configured to release the striker 148 when a vehicle passenger exerts and releases a downward (as viewed in FIG. 8) force on surface 72.

The screen assembly 64A is movable from its deployed position to its retracted position by exerting a force on the surface 72 sufficient to overcome the bias of the springs 124 and move the screen assembly 64A until the striker 148 engages the latch 144.

Referring specifically to FIG. 10, the first panel 106 defines a plurality of slots 152 that are elongated in the direction of movement of the screen assembly 64A. The carriage member 92A includes a plurality of protrusions 156, each of which extends into a respective slot 152. Accordingly, the slots 152 and the protrusions 156 further restrict movement of the screen assembly 64A to substantially linear translation. A dampening gear 158 is mounted to the carriage member 92A and is configured to dampen movement of the screen assembly 64A as it moves between its retracted and deployed positions, as understood by those skilled in the art. In an alternative embodiment, and within the scope of the claimed invention, a cross-car linear axle with a gear mounted may be employed as a secure method of gliding on a track to prevent racking or loose wobbling of screen.

Active materials that generate a force in response to an activation signal may be employed to move the screen assembly 64A between the retracted and deployed positions. For example, in an alternative embodiment, actuator 98 is an active material actuator configured to selectively raise the screen assembly 64A from its retracted position to its deployed position. In another alternative embodiment, an active material actuator is employed to retract the screen assembly 64A from its deployed position to its retracted position, and the spring 124 is employed to raise the screen assembly 64A to its deployed position. An exemplary active material based actuator is depicted in FIGS. 12 and 13.

Referring to FIGS. 12 and 13, wherein like reference numbers refer to like components from FIGS. 1-11, an alternative screen apparatus 160 is schematically depicted. Screen apparatus 160 is mountable to the rear surface (shown at 34 in FIG. 1) of the seatback portion (shown at 18 in FIG. 1). Apparatus 160 includes a screen assembly 64B, a screen guide assembly 96A, and an actuator 98A. The screen assembly 64B includes screen frame 68B and screen 66B. The screen 66B is mounted to the screen frame 68B for movement therewith.

Actuator 98A includes a member 164 comprising an active material that is configured to generate a force in response to an activation signal (stimulus). In an exemplary embodiment, member 164 is flexible and is comprised of shape memory alloy (SMA). Member 164 interconnects a first link 168 and a second link 172. The first link 168 is rotatably mounted to the guide assembly 96A by pivot 176. The second link 172 is rotatably mounted to the guide assembly 96A by pivot 180. The frame 68B includes a member 184 that defines first and second slots 188A, 188B. A member 192A is positioned within slot 188A for translation therein. A member 192B is positioned within slot 188B for translation therein. The slots 188A, 188B are horizontally elongated, and therefore movement of the members 192A, 192B with respect to member 184 is restricted to substantially horizontal translation. Link 168 is rotatably connected to member 192A. Link 172 is rotatably connected to member 192B.

A shape memory alloy is characterized by a cold state, i.e., when the temperature of the alloy is below its martensite finish temperature M_{f}. A shape memory alloy is also characterized by a hot state, i.e., when the temperature of the alloy is above its austenite finish temperature A_{f}. An object formed of the alloy may be characterized by a predetermined shape. When the object is pseudo-plastically deformed from its predetermined shape in the cold state, the strain may be reversed by heating the object above its austenite finish temperature A_{f}, i.e., heating the object above its A_{f} will cause the object to return to its predetermined shape. An SMA's modulus of elasticity and yield strength are also significantly lower in the cold state than in the hot state. As understood by those skilled in the art, pseudo-plastic strain is similar to plastic strain in that the strain persists despite removal of the stress that caused the strain. However, unlike plastic strain, pseudo-plastic strain is reversible when the object is heated to its hot state. Thus, in the case of SMA, the activation signal or stimulus is heat.

Member 164 is characterized by a predetermined length (shape), and is configured such that member 164 is characterized by tensile strain when the screen assembly 64B is in its deployed position, as shown in FIG. 12, and is thus longer than its predetermined length. When the member 164 is heated to the hot state, it decreases in length to its predetermined length, thereby causing the links 168, 172 to rotate toward each other. As the links 168, 172 rotate, they draw the members 192A, 192B downward, which in turn draws member 184 downward. The screen 66B is mounted to member 184, and thus the downward movement of member 184 causes the screen 66B to move downward below the slot 120 at the top of the guide assembly 96A. Accordingly, heating the SMA member 164 to its hot state causes the screen assembly 64B to translate from its deployed position to its retracted position, as shown in FIG. 13.

A spring, such as the one shown at 124 in FIG. 8, is employed to raise the screen assembly 64B to its deployed position from the retracted position. As the spring raises the screen assembly 64B to its deployed position, as shown in FIG. 12, the SMA member 164 is subjected to tensile strain and is thus reset for moving the screen assembly 64B to its retracted position upon reheating. A latch (not shown in FIGS. 12 and 13) may be employed to releasably retain the screen assembly 64B in its retracted position. Alternatively, and within the scope of the claimed invention, an SMA member is employed to deploy the screen assembly and the spring is employed to retract the screen assembly. Alternatively, the SMA member may be employed to retract the screen assembly and another SMA member is employed to deploy the screen assembly.

Other active materials may be employed within the scope of the claimed invention, such as electroactive polymers, piezoelectric materials, magnetostrictive and electrostrictive materials, etc.

Heating of an SMA member may be achieved by electrical resistance heating controlled by an electronic controller (not shown) that is programmed to cause the actuator assembly 10 and its subsystems to perform as described herein. Exemplary SMA members include wires or sets of wires. It may be desirable for a flexible SMA member to comprise a plurality of wires rather than a single wire.

A panel, such as the one shown at 70 in FIG. 7, is mounted to the guide assemblies 96, 96A so that apparatuses 94, 160 have the general appearance and functionality of module 46B. As used herein, a “panel” may be characterized by any material, construction, or shape. It should be noted that a screen apparatus, screen assembly, actuator, latch, and panel may or may not be part of an interchangeable or preassembled module within the scope of the claimed invention. For example, panel 70 may define most or all of the rear surface of a seatback portion and define a slot through which a screen assembly is translatable. It should also be noted that a screen guide may have any configuration within the scope of the claimed invention. For example, the panel 70 and the seatback portion 18 may cooperate to define a screen guide that restricts movement of the screen assembly to linear translation. A panel may define part or all of a screen guide within the scope of the claimed invention.

The actuators in the embodiments depicted include active material actuators and springs. Other actuators, such as electric motors and solenoids, may be employed within the scope of the claimed invention. In an alternative embodiment, a screen module or apparatus may include an actuator configured to selectively rotate a screen with respect to a panel. Within the scope of the claimed invention, a screen module or apparatus may be configured such that actuators and/or latches are operable by remote control. For example, a hand-held remote control may transmit signals to a lens (such as the lens shown at 75), which is operatively connected to actuators to cause the movement of the screen.

Referring to FIG. 14, wherein like reference numbers refer to like components from FIGS. 1-13, a vehicle 200 is schematically depicted. The vehicle 200 includes a vehicle body 204, which defines a passenger compartment 208. The vehicle body 204 includes a floor 212 that defines the lower extent of the passenger compartment 208. The vehicle body 204 also includes a roof 214 that defines the upper extent of the passenger compartment 208. Vehicle seat 10 is mounted with respect to the body 14 and disposed within the passenger compartment 208. A rear seat 218 is disposed within the passenger compartment 208 directly behind seat 10, so the screen of module 46B is viewable by an occupant of the rear seat 218 when the screen is deployed.

Those skilled in the art will recognize a variety of locations within a passenger compartment for the installation of a screen apparatus that may be employed within the scope of the claimed invention. For example, as shown in FIG. 14, screen apparatus 94 is mounted with respect to the roof 214 and may, for example, be integrated into a headliner (not shown). As installed in FIG. 14, the apparatus 94 is oriented such that the screen assembly translates horizontally between the deployed and retracted positions. The screen is generally horizontal when the screen assembly is in the deployed position. The screen is then rotated about pin (shown at 104 in FIG. 8) to a generally vertical position for viewing.

In the embodiment depicted, vehicle 200 is a minivan. Other body styles, such as a bus, sport utility vehicle, van, station wagon, sedan, etc., may be employed within the scope of the claimed invention. Other vehicles may be employed within the scope of the claimed invention. For example, a “vehicle” may include aircraft, passenger trains, automotive vehicles, etc.

As set forth in the claims, various features shown and described in accordance with the different embodiments of the invention illustrated may be combined.

While the best modes for carrying out the invention have been described in detail, those familiar with the art to which this invention relates will recognize various alternative designs and embodiments for practicing the invention within the scope of the appended claims.

1. A vehicle comprising:
a vehicle body defining a passenger compartment;
a screen apparatus including a screen assembly and structure;
said structure defining a cavity having an opening to the passenger compartment;
said screen assembly including a frame and a video screen mounted with respect to the frame; and
wherein the screen assembly is selectively movable through the opening between a retracted position in which the screen is inside the cavity and concealed from view, and a deployed position in which the screen is outside the cavity and visible from the passenger compartment; and
wherein the screen apparatus is configured such that the movement of the screen assembly between the retracted and deployed positions is restricted to substantially linear translation.

2. The vehicle of claim 1, wherein the screen is selectively pivotable with respect to the structure when the screen assembly is in the deployed position.

3. The vehicle of claim 1, further comprising at least one actuator configured to selectively move the screen assembly relative to the structure.

4. The vehicle of claim 3, wherein said at least one actuator includes a spring that urges the screen assembly toward the deployed position when the screen assembly is in the retracted position.

5. The vehicle of claim 4, further comprising a latch mounted with respect to one of the structure and the screen assembly; and
a striker mounted with respect to the other of the structure and the screen assembly;
wherein the latch and the striker are positioned to engage one another when the screen assembly is in the retracted position thereby to releasably retain the screen assembly in the retracted position.

6. The vehicle of claim 5, wherein the latch is a toggle latch; and
wherein the latch is configured to release the striker when the frame is pressed.

7. The vehicle of claim 4, wherein said at least one actuator further includes an active material actuator having an active material member configured to generate a force in response to a stimulus; and
wherein the active material member is operatively connected to the screen assembly such that the force urges the screen assembly toward the retracted position.

8. The vehicle of claim 3, wherein said at least one actuator includes an active material actuator having an active material member that is configured to generate a force in response to a stimulus; and
wherein the active material member is operatively connected to the screen assembly such that the force is transmitted to the screen assembly.

9. A vehicle seat assembly comprising:
a seat including a lower seat portion and a seatback portion mounted with respect to the lower seat portion;
a panel mounted with respect to the seatback portion;
a screen assembly including a frame and a video screen mounted with respect to the frame; and
wherein the screen assembly is selectively movable between a retracted position in which the screen is obstructed by the panel and a deployed position in which the screen is not obstructed by the panel; and
wherein the movement of the screen assembly between the retracted and deployed positions is restricted to substantially linear translation.

10. The vehicle seat assembly of claim 9, wherein the screen is higher when the screen assembly is in the deployed position than when the screen assembly is in the retracted position.

11. The vehicle seat assembly of claim 10, wherein the seat includes a head restraint operatively connected to the seatback portion; and
wherein at least part of the screen is directly rearward of the head restraint when the screen assembly is in the deployed position.

12. The vehicle seat assembly of claim 9, wherein the screen is selectively pivotable with respect to the seatback portion when the screen assembly is in the deployed position.

13. The vehicle seat assembly of claim 9, further comprising at least one actuator configured to selectively move the screen assembly relative to the seatback portion.

14. The vehicle seat assembly of claim 13, wherein said at least one actuator includes a spring.

15. The vehicle seat assembly of claim 13, further comprising a latch mounted with respect to one of the seatback portion and the screen assembly; and
a striker mounted with respect to the other of the seatback portion and the screen assembly;
wherein the latch and the striker are positioned to engage one another when the screen assembly is in the retracted position thereby to releasably retain the screen assembly in the retracted position.

16. The vehicle seat assembly of claim 15, wherein the latch is a toggle latch; and wherein the latch is configured to release the striker when the frame is depressed.

17. The vehicle seat assembly of claim 13, wherein said at least one actuator includes an active material actuator having an active material member that is configured to generate a force in response to a stimulus; and
wherein the active material member is operatively connected to the screen assembly such that the force is transmitted to the screen assembly.

18. The vehicle seat assembly of claim 17, wherein the active material member comprises one of a shape memory alloy, an electroactive polymer, a piezoelectric material, a magnetostrictive material, and an electrostrictive material.

19. The vehicle seat assembly of claim 9, wherein the panel, the screen guide, and the screen assembly are part of a preassembled module mounted with respect to the seatback portion.

20. The vehicle seat assembly of claim 19, wherein the seatback portion defines a cavity; and wherein the preassembled module is at least partially contained within the cavity.
